(19) United States
(12) Patent Application Publication
(10) Pub. No.: US 2020/0111081 A1
(43) Pub. Date: Apr. 9, 2020

(54) CHILD TOKENS FOR DIGITAL WALLETS

(71) Applicant: Mastercard International Incorporated, Purchase, NY (US)

(72) Inventor: Manu Dharmaiah Kallugudde, Mumbai (IN)

(21) Appl. No.: 16/150,535

(22) Filed: Oct. 3, 2018

(51) Int. Cl. G06Q 20/36; G06Q 20/38; G06Q 20/32; G06Q 20/34

(52) U.S. Cl. CPC G06Q 20/3672; G06Q 20/385; G06Q 20/352; G06Q 20/3278; G06Q 20/35785; G06Q 20/3678

(57) ABSTRACT

Provided are systems and methods for generating a child token for a digital wallet. In one example, the method may include receiving a request to generate an additional token from a mobile device, identifying a parent token previously issued to the mobile device and comprising a non-sensitive tokenization element linked to a payment credential at a tokenization platform, generating a child token of the parent token at the tokenization platform, the child token including a different non-sensitive tokenization element than the non-sensitive tokenization element of the parent token and being linked to the parent token at the tokenization server, and transmitting the child token to a receiving device. The child token and the parent token can be processed at the same time in different payment transactions while being linked to the same payment card.

### BACKGROUND

The Payment Card Industry Data Security Standard (PCI DSS) is an industry-wide set of guidelines that must be met by an organization (e.g., merchant, etc.) that stores, processes, or transmits cardholder data. The PCI DSS mandates that credit card data must be protected when it is stored. Tokenization is often implemented to meet this mandate. Tokenization replaces a credit/debit card number (e.g., a primary account number (PAN)) with a non-sensitive value (i.e., a token) such as a random number or string of characters. The token can be used to prevent fraud or unauthorized access to sensitive payment card information.

Tokens can be formatted in different ways including a format of the original sensitive data. For payment cards, the token may have the same length as the PAN and may contain elements of the original PAN data such as the last four digits. The token can be stored by the merchant without having to fully adhere to PCI DSS while the actual cardholder data is mapped to the token at a secure tokenization system that is distinct from the merchant. Tokenization essentially turns a mobile device into a payment vehicle which can transact payments at merchant terminals similar to a payment card being swiped or a chip being read, except that the tokenized information may be transmitted wirelessly.

However, tokenization is limited in that a token is mapped to an individual who is allowed to perform the transaction. In other words, despite being implemented via a mobile device, a token is still only usable by the individual who is mapped to the token in a same fashion that an actual payment card is only usable by the named individual printed on the card. As a result, drawbacks occur when another user authorized by the consumer desires to make a purchase or when the consumer needs to process multiple payments at the same time. In these cases, the consumer must use multiple payment card accounts. Accordingly, what is needed is a more flexible system for tokenized payments.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings.

FIG. 1A is a diagram illustrating a process of tokenizing a payment card according to an example embodiment.

FIG. 1B is a diagram illustrating a process of generating a child token of the parent token generated in FIG. 1A, according to an example embodiment.

FIG. 2 is a diagram illustrating a child token being generated and mapped to a parent token at a tokenization platform according to an example embodiment.

FIG. 3A is a diagram illustrating a process of a mobile device performing multiple payments at the same time, according to an example embodiment.

FIG. 3B is a diagram illustrating a payment processing system processing the multiple payments of FIG. 3A, according to an example embodiment.

FIG. 4 is a diagram illustrating a method of generating a child token for mobile payments according to an example embodiment.

FIG. 5 is a diagram illustrating a computing system for generating child tokens according to an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

Tokenization enables a cardholder to digitize a payment card and store the digitized payment information on a mobile device. As a result, the mobile device may be used for transacting payments at merchant terminals in a similar manner as a swipe or chip transaction with a plastic card, a fob, or the like. The example embodiments extend the tokenization process of payment cards by creating child tokens which depend from and are mapped to a parent token at a tokenization platform. A child token may be generated at the request of a digital wallet user of the mobile device (parent token holder) and implemented with customized restrictions that can be dynamically added by the parent token holder enabling customized payment uses. Furthermore, in some cases, funds from the payment card associated with the parent token can be attached to the child token enabling “express” payment processing which does not rely on an issuing bank of the payment card for approval. The express payments can save significant time (e.g., 30 seconds, etc.) for processing a payment for the child token in comparison to traditional token-based payments.

The tokenization platform may generate or receive an initial token based on a payment card (or other payment account) and store the initial token within a digital wallet of the mobile device. The initial token is referred to herein as a “parent token” which can be used for transacting payments with a merchant terminal such as a point of sale (POS), a point of interaction (POI), an online shopping portal, and the like. According to various embodiments the tokenization platform may generate child tokens based on the parent token. A child token may be mapped to the parent token at the tokenization platform and may share the same payment card as the parent token. However, the child token may have a different non-sensitive element (e.g., token ID) which causes the child token to appear as if it is a different payment card (or other payment mechanism) than the parent token. In this way, both the child token and the parent token can be used at the same time (overlapping) to conduct payment transactions on the same payment card.

One such use case for the child token is a transit station which requires each user entering the station to swipe a different payment card at the payment terminal. In other words, the transit station payment terminal may prevent a payment card from being used for multiple transit riders at the same time and may require each user to have a different payment card. In this use case, there are times when a parent is travelling with a child, or one user is travelling with another user who does not have money or who does not have a payment card (lost, stolen, etc.). The child token creation system described herein solves this dilemma and allows a cardholder (e.g., a parent, etc.) with a digital wallet to create a child token (e.g., for a child, another person, etc.) which can be read and processed at the same time (during the same trip) as a parent token in the digital wallet, without requiring the other person to use separate payment card information.

In this example, when the parent token is read by the transit terminal, the child token may be read in sequence before the parent token has finished processing. Because each of the parent token and the child token appear as different payment mechanisms, the parent token and the child token can be processed at the same time, in a partially overlapping period of time. Even though both tokens appear to be different payment mechanisms, each token is mapped to the same payment card at the tokenization system. Furthermore, in some cases, only the parent token is transmitted to the payment network for approval from an issuing bank while the child token is authorized via an express payment process which is performed by the tokenization server and which does not require transmission/approval from the bank.

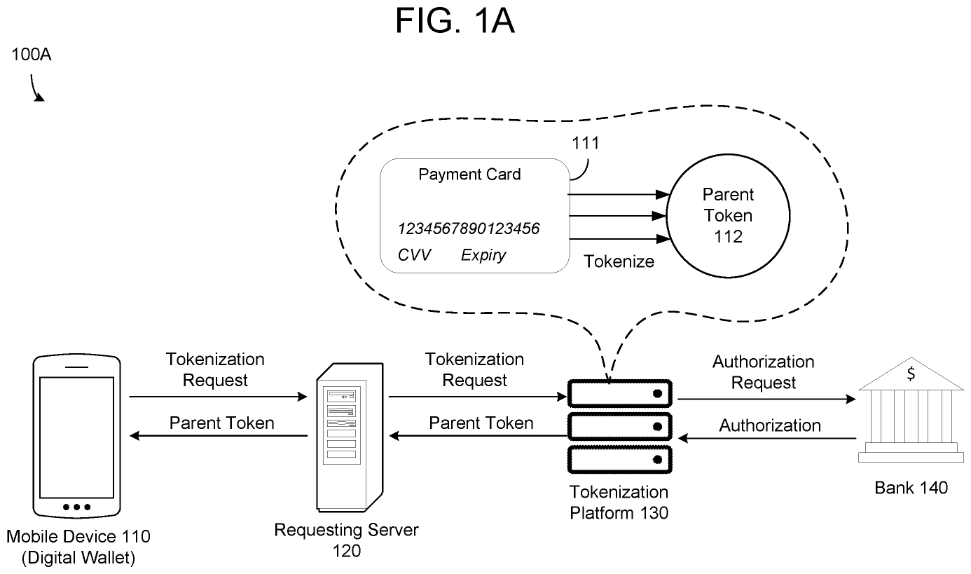

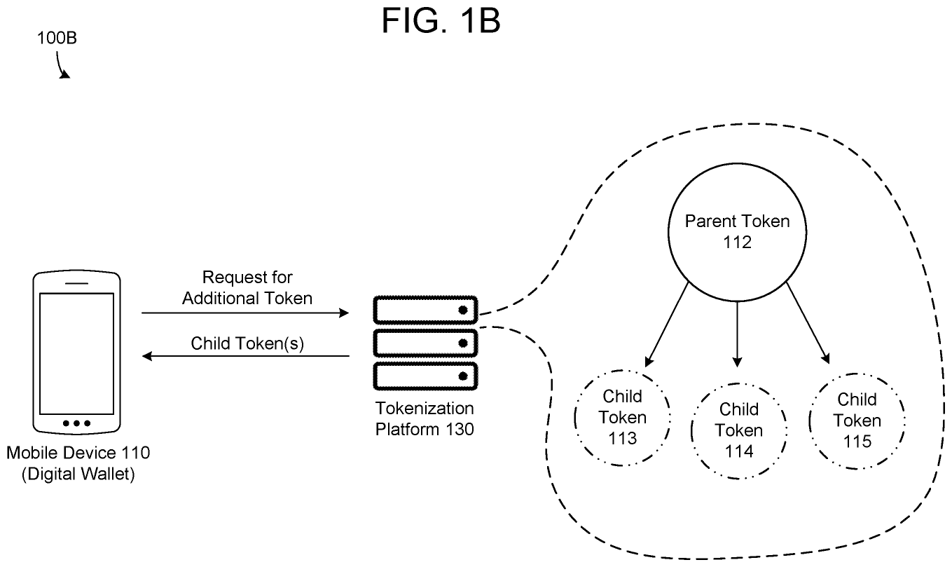

FIG. 1A illustrates a process 100A of tokenizing a payment card according to an example embodiment, and FIG. 1B illustrates a process 100B of generating a child token for a parent token generated by the tokenization in FIG. 1A, according to an example embodiment. In the examples described herein, payment credentials from a payment card 111 are tokenized or otherwise converted into a parent token 112, but it should be understood that payment data from any known type of payment account (e.g., savings, cryptocurrency, credit union, etc.) may be tokenized and does not need to be embodied in the form of a plastic card. The parent token 112 may be stored within a mobile device 110 associated with the payment card 111 and may be used to process payments via a payment application and/or digital wallet stored on the mobile device.

Referring to FIGS. 1A and 1B, a mobile device 110 executing a digital wallet application transmits a tokenization request to a tokenization platform 130, via a requesting server 120. In this example, the requesting server 120 may be associated with the digital wallet on the mobile device 110. The tokenization request may include information about the payment card 111 as well as authentication information (e.g., PIN, biometric data, username, password, etc.) which may be used to verify that the user of the mobile device 110 is the owner of the payment card and/or the owner of the digital wallet. The tokenization platform 130 may receive the request and verify that the digital wallet/user of the mobile device is authorized to perform the tokenization by transmitting a request including the authentication information to the bank 140 which issued the payment card 111.

In response to successful authorization from the bank 140 being received, the tokenization platform 130 may “tokenize” sensitive information from the payment card 111 by substituting a token in place of the sensitive payment information, also referred to in FIG. 1A as a parent token 112. The tokenization platform 130 may replace sensitive data elements (e.g., PAN, expiry, CVC, etc.) of the payment card with a non-sensitive equivalent that has no extrinsic or exploitable meaning or value and store the non-sensitive elements in the parent token 112.

As an example, the token (or token ID) may include a random number, a string of characters, or the like. The token itself may not be a payment-enabled card number but is instead a substitute for the card number that has a same format (length, digits, appearance, etc.) as the actual card number without exposing the sensitive card number. Therefore, if an unauthorized party were to gain access to the token, the token number stored on the mobile device 110 can't be extracted into anything valuable for fraudsters. Furthermore, the token fits into a payment message (e.g., payment authorization, payment request, etc.) having an ISO 8583 format which can be processed through existing payment networks.

In the examples of FIGS. 1A and 1B, the parent token 112 includes the non-sensitive element instead of the actual card number which may also be used as a reference (i.e., an identifier) that maps back to the sensitive payment data of the payment card 111 at the tokenization platform 130. The mapping from original payment card 111 data to the parent token 112 renders the parent token 112 infeasible in the absence of the tokenization platform 130 to perform a reverse mapping. The tokenization platform 130 can provide one or more application programming interfaces (APIs) which enable digital wallets to request tokens, or detokenize back a pre-existing token to sensitive data.

The security and risk reduction benefits of tokenization may be ensured when the tokenization platform 130 is logically isolated and segmented from data processing systems and applications (e.g., mobile payment applications, digital wallets, etc.). The token generation method performed by the tokenization platform 130 may be a method which is proven to have the property that there is no feasible means through direct attack, cryptanalysis, side channel analysis, token mapping table exposure or brute force techniques to reverse tokens back to the original payment card data.

The parent token 112 may be provided to the mobile device 110 and stored within the digital wallet executing therein. The parent token 112 may be used to conduct payments from the mobile device such as through a mobile payment application associated with the digital wallet. Mobile payments may include contactless payments (e.g., near-field communications, radio frequency identification, etc.), online shopping payments, and the like. For example, using the mobile device 110, a user may bring the mobile device 110 within proximity of a point-of-sale (POS) terminal configured for contactless payments which causes the mobile device 110 to wirelessly transmit the parent token 112 from the mobile device 110 to the POS terminal. As another example, the parent token 112 may be used for online shopping through a website, online portal, and the like.

In FIG. 1A, a cardholder/consumer tokenizes the payment card 111 into the digital wallet application on the mobile device 110. Here, the mobile device 110 receives the parent token 112 which is stored on the mobile device 110 such as within a secure element or trusted execution environment. The parent token 112 can be used for transactions via mobile payment applications on the mobile device 110 for in-store purchases (e.g., contactless, etc.) and online payments.

For example, contactless payment systems enable smartphones and other mobile devices to use near field communication (NFC) or radio-frequency identification (RFID) to transfer payment information wirelessly such as Apple Pay®, Samsung Pay®, Google Wallet®, and the like. The embedded chip and antenna enable consumers to wave or otherwise swipe their handheld device over a reader at a mPOS terminal. Contactless payments are made in close physical proximity, unlike mobile payments which use broad-area cellular or Wi-Fi networks and do not usually involve close physical proximity.

FIG. 1B illustrates a process 100B in which child tokens 113-115 are created based on the parent token 112 which was generated in FIG. 1A. For example, through the digital wallet on the mobile device 110, the cardholder can select an option to create one or more child tokens that depend from the parent token 112. In the example of FIG. 1B, the consumer may create multiple child tokens 113-115 and assign a name to each child token so that consumer is aware of who is associated with each child token. The amount of child tokens that a consumer is able to create may be set by an issuer of the payment card associated with the parent token 112.

Each of the child tokens 113-115 may be created by the tokenization platform 130 and may be mapped to the parent token 112 at the tokenization platform 130 and also at the mobile wallet application on the mobile device 110. To create the child tokens 113-115, the tokenization platform 130 may generate a new/different token for each child token with respect to the parent token 112 such that each child token 113-115 appears to be a different payment card when read by a POS terminal. In doing so, the example embodiments create multiple payment methods (token IDs) which can be used at the same time to execute different transactions on a single payment card 111.

Similar to the parent token 112, the child tokens 113-115 may be distributed back to the mobile device 110 or another device (not shown) by the tokenization platform 130. In this example, the mobile device 110 may perform network communication directly with the tokenization platform 130 via the digital wallet or other application executing on the mobile device 110. The child tokens 113-115 may be stored in a secure area of the mobile device 110 such as the secure element, trusted execution environment, and the like, and may be used by the digital wallet and/or mobile payment application on the mobile device 110 to process payments with POS terminals in-store and online.

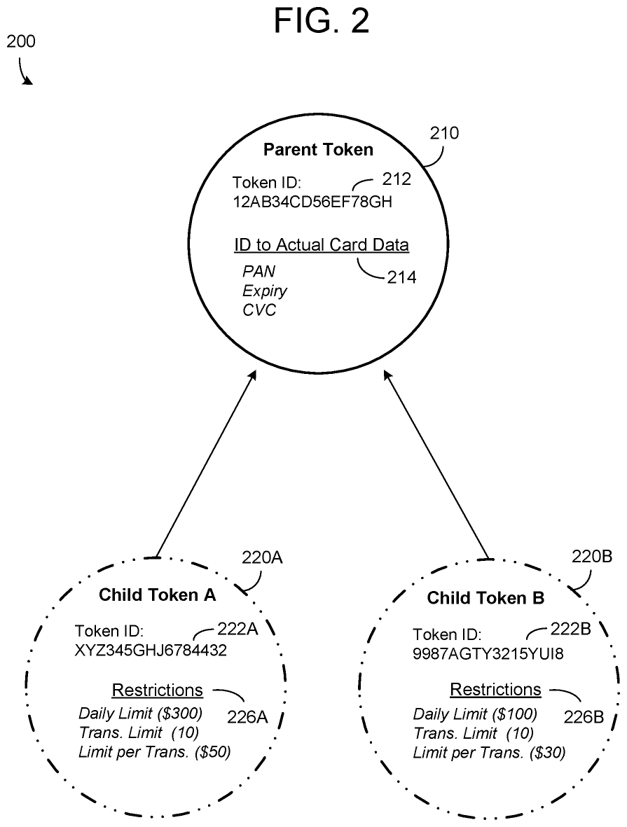

FIG. 2 illustrates process 200 of mapping a child token to a parent token according to an example embodiment. Referring to the example of FIG. 2, a parent token 210 is a digital representation of a payment card data 214 (e.g., PAN, expiry, CVC, etc.) The parent token 210 also includes a non-sensitive element 212 which has a format of a payment card but which is not a payment-enabled number. Instead, the non-sensitive element 212 is a substitute for a payment card data. Meanwhile, the tokenization server may maintain a mapping between the actual payment card data and the non-sensitive element 212 based on an identifier 214 of the payment card data at the tokenization server. The parent token 210 may be used to perform mobile payments through a digital wallet. In this example, the parent token 210 has two dependent child tokens 220A and 220B. Each child token 220A and 220B may be mapped to the parent token 210 at the tokenization server (e.g., tokenization server 130 in FIGS. 1A and 1B).

According to various embodiments, the child tokens 220A and 220B may each include different token values which include different non-sensitive elements 222A and 222B with respect to the non-sensitive element 212 of the parent token 210. Accordingly, the non-sensitive elements 222A and 222B appear as if they are linked to different payment cards than the parent token 210 and than each other. However, the tokenization server may maintain a mapping between the non-sensitive elements 222A and 222B of the child tokens 220A and 220B and the identifier 214 of the actual card data represented by the non-sensitive element 212 of the parent token 210. Accordingly, a mapping between the non-sensitive elements 222A and 222B of the child tokens 220A and 220B may be indirectly maintained with the payment card data represented by the parent token 210.

According to various embodiments, restrictions 226A and 226B may be added to the child tokens 220A and 220B which can restrict how, when, where, etc., the child tokens 220A and 220B can be used. For example, the restrictions 226A and 226B may be applied to the child tokens 220A and 220B through inputs via a user interface provided by the digital wallet at the mobile device. The restrictions 226A and 226B may include one or more of a daily spending limit, a total transactional limit, a spending limit per transaction, and the like. Also, as further explained below, the daily spending limits can be guaranteed through an express payment holding.

According to various embodiments, funds can be attached to the child tokens 220A and 220B, in advance. The funds can be guaranteed to be available enabling express payment processing. For example, the cardholder and/or the issuer bank may set a daily limit which can be utilized for express payments. The daily limit may be blocked from the consumer account/card daily and may be kept in a holding account for the cardholder until the end of the day. The amount of funding that is held may be enough to satisfy the maximum daily limits of all available child tokens 220A and 220B. Accordingly, when the child tokens 220A and/or 220B are submitted to a merchant terminal for payment processing, the merchant terminal merely requests/verifies an amount left on the daily limit of the child token with the tokenization server and does not need to process the payment through the rails of a traditional payment processing network.

According to various embodiments, funds may be attached to the child token for express payments by a user interacting with the child token via the digital wallet. This can be a user driven process. For example, the user may choose to attach a value to the child token in the digital wallets itself. In response, the digital wallet may send an authorization message (e.g., ISO 8583, etc.) to the tokenization platform which then gets forwarded to an issuer for authorization approval. Once issuer approves, the value gets attached to the child token by the tokenization platform. During actual payment at a POS terminal, the user of the digital wallet can just tap at the POS terminal with the value associated child token, and the POS terminal may perform only a basic check (token validity and funds availability check) to approve the transaction without following a traditional channel through the acquirer, tokenization platform, issuer, etc. This expedited/express processing can save significant time (e.g., 30 seconds or more) during the actual payment process.

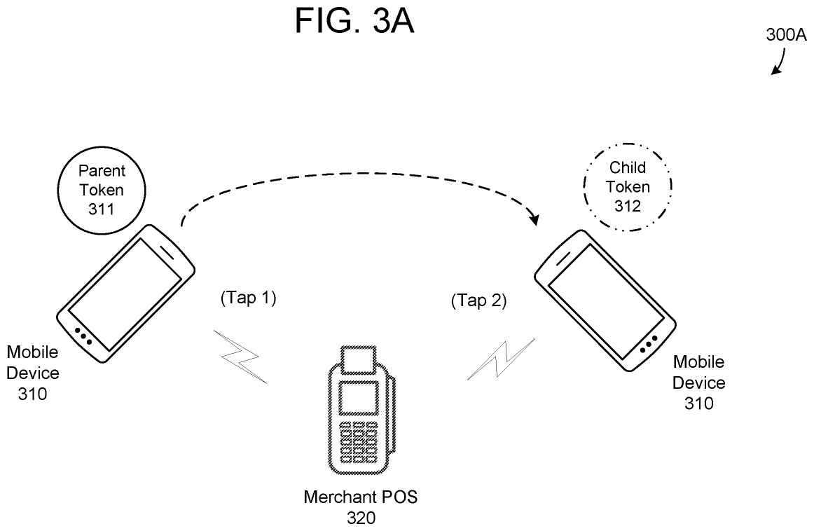

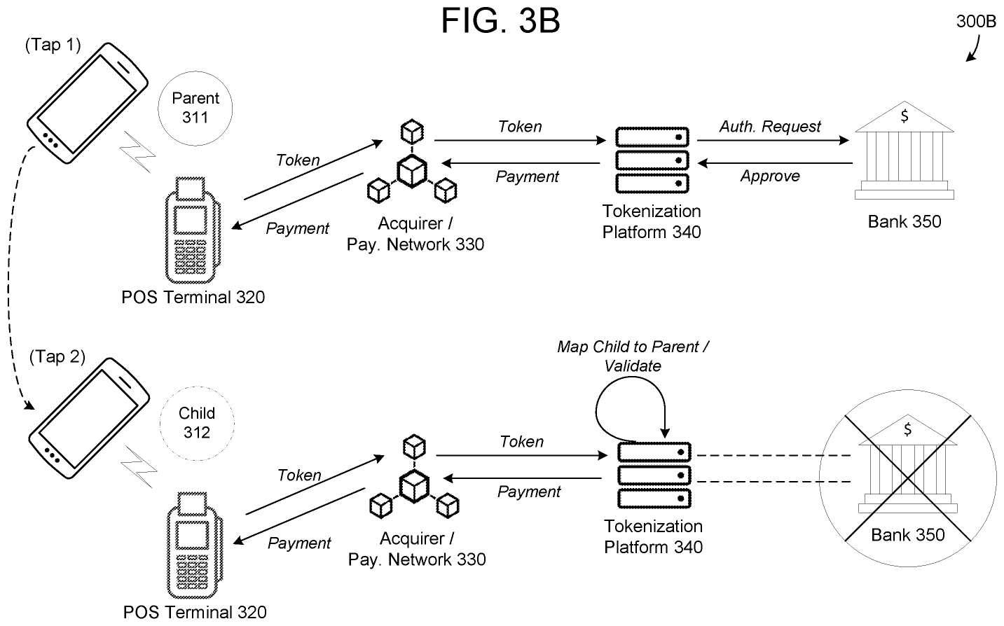

FIG. 3A illustrates a process 300A of a mobile device 310 performing multiple payments through a merchant POS 320 at the same time, according to an example embodiment, and FIG. 3B illustrates a payment process 300B that is performed in response to each payment (tap) in the process of FIG. 3A, according to an example embodiment. Referring to FIG. 3A, during a first tap of the process 300A, the mobile device 310 transfers a parent token 311 to the merchant POS terminal 320. Meanwhile, during a second tap of the process 300A, the mobile device 310 transfers a child token 312 to the merchant POS terminal 320.

Here, the same mobile device 310 can submit the parent token 311 and the child token 312, for example, by changing parameters on a screen of the mobile device (via the digital wallet). An example scenarios is two people entering a transit station which requires each rider to use different credit card accounts to receive a valid boarding pass/ticket. Here, because the child token 312 has a different non-sensitive element than the parent token 311, the POS terminal 320 reads the payments as being submitted from different payment cards/accounts. However, what is unknown to the POS terminal 320 is that both the parent token 311 and the child token 312 are mapped to the same payment card account at a tokenization server. Because the two taps appear to be from different payment cards, both taps may create a payment process through the merchant POS terminal 320 that can be executed at the same time. In other words, the first tap and the second tap may trigger payment processes that partially overlap in time.

Referring to FIG. 3B, a process 300B of each of the taps performed in FIG. 3A is shown. In this example, only the parent token 311 is validated for funding with a bank that issued the payment card associated with the parent token 311. Meanwhile, the child token 312 may be processed by a tokenization platform 330 without a need for verifying funding from a bank or the need for submitting the payment for processing via a backend payment network. As a result, a significant amount of time can be saved.

In the example of FIG. 3B, both of the parent token 311 and the child token 312 are transferred from the POS terminal 320 to the tokenization platform 340 via an acquiring bank of the merchant and a payment network (e.g., payment gateway, payment processor, etc.). However, in the processing of the first tap involving the parent token 311, the payment processing is performed in a traditional way by ensuring the funds associated with the payment account mapped to the parent token 311 are available with bank 350. Here, the tokenization platform 340 receives the parent token 312, maps the parent token to the proper payment card information stored at the tokenization platform 340, and requests authorization from the bank 350 based on the information stored at the tokenization platform 340. In response to receiving notice from the bank 350 that the funds are available, the payment is processed successfully and notice is sent to the POS terminal 320.

However, in the processing of the second tap, the bank 350 does not need to be contacted and instead an express pay can occur which allows for simultaneous payment processing on the same payment account. For example, a cardholder can set a daily limit and/or transaction limit which can be utilized for express payments. This daily limit is blocked from the consumer account/card daily and kept in a holding account until an end of day time periods. The holding account guarantees that each and every transaction of the child token 312 with previously authorized funds which are attached to the child token 312.

In the example of FIG. 3B, the merchant POS terminal 320 may receive tokenized information including both the child token 312 and the parent token 311, along with the daily limit parameters for express payment from the mobile wallet application executing on the mobile device 310. Here, the transfer of the payment tokens and the daily limit may be performed via contactless payment transactions (e.g., NFC, etc.) which may be referred to as a tap and pay payment. To perform the tap and pay, the cardholder/consumer may open the mobile wallet application, select a card for payment, and receive an option to select the child token 312 which is configured in the mobile wallet application. In this example, when the cardholder taps the mobile device 310 at the merchant POS terminal 320 both the child token 312, the parent token 311, and the daily limit may be transferred to the POS terminal 320.

In response to receiving the daily limit parameter along with the token information, the merchant POS terminal 320 may perform a basic check to verify whether the token information (i.e., child token 312 is mapped to parent token 311 at tokenization platform 340) and daily limit information are valid. This process can take less than a second. If valid, the merchant POS terminal 320 can directly authorize the transaction. In other words, there is no lag time as the merchant POS terminal 320 does not verify/authorize the transactions through issuer banks in real-time. With the second tap, there is no authorization may be performed as the child token 312 may have the authorized funds attached to it. By attaching the funds directly to the child token 312, the example embodiments drastically reduce an amount of time to perform transactions at the POS terminal 320 (e.g., from 30 seconds to 1 second) because a back-end back does not need to be contacted.

In the backend, after the payment is completed, the merchant POS terminal 320 may initiate a normal clearing and settlement cycle with the issuer bank 350 through an existing network for transfer of funds from a holding account to a merchant account. Once the authorization request is received by the network and reaches the tokenization platform 340, the tokenization platform 340 may take the parent token 311 and the child token 312 and perform the validation. If there are funds remaining in the child token 312 at the end of the day, the consumer can either choose to refund the amount back to their account or they can re-assign them for next day's transaction. If the merchant receives more funds during the transaction, the merchant can issue a refund to the consumer with the existing refund process.

In some embodiments, the tokenization platform 340 may enforce different security measures to protect and limit the usage of the child tokens 312. For example, a single use key may be implemented with a child token 312 in order to limit the number of transactions that the token can be used for. As another example, the child token 312 may be tied to a device via the device ID (IMEI, etc.). In this case, if a hacker takes the child token 312 and tries payment through another device, payment will fail.

The child token 312 provides numerous benefits over traditional tokenized payment processing tokens because the child token 312 does not need to be verified by an issuing bank. In addition, due to the restrictions that can be added, the child token 312 can be customized dynamically based on user interests and can be set for multiple uses based on user need. Furthermore, funds may be attached to the child token 312 allowing for express payments which can be performed at the same time as a payment with a parent token is being processed. Examples of use cases where express payments can be beneficial include transit systems, tolls, parking, in-store payments, and the like. In these situations, the removal of the need to process payments through a payment network/issuing bank backend can save significant amounts of processing time (e.g., 30 seconds or more).

According to various embodiments, the child token 312 may look similar to a parent token and may include, for example, a 16 digit token that follows BIN ranges of a card provider. In some embodiments, during payment, the child token 312 may be treated as the main payment instrument and added to a PAN data element field of an ISO 8583 authorization message (e.g., data field 2) while the parent token 311 may be appended to another data element field of the authorization message such as a private use data element DE124, or the like, of the ISO 8583 message. In this example, the child token 312 in the first data element (e.g., data field 2, etc.) and the parent token 311 in the second data element (e.g., data field 124, etc.) may be passed to the tokenization platform 340 for validation. In response, the tokenization platform 340 may perform a validation of both tokens and a cryptogram and may detokenize the tokens and forward the request to issuer for final authorization (if it is not an express payment). Furthermore, when the tokenization platform 340 receives the authorization request from the mobile device in which the private use data element is filled, it may detect or otherwise understand that the transaction includes both the child token in the traditional PAN data element (data element 2) and the parent token in the private use field element.

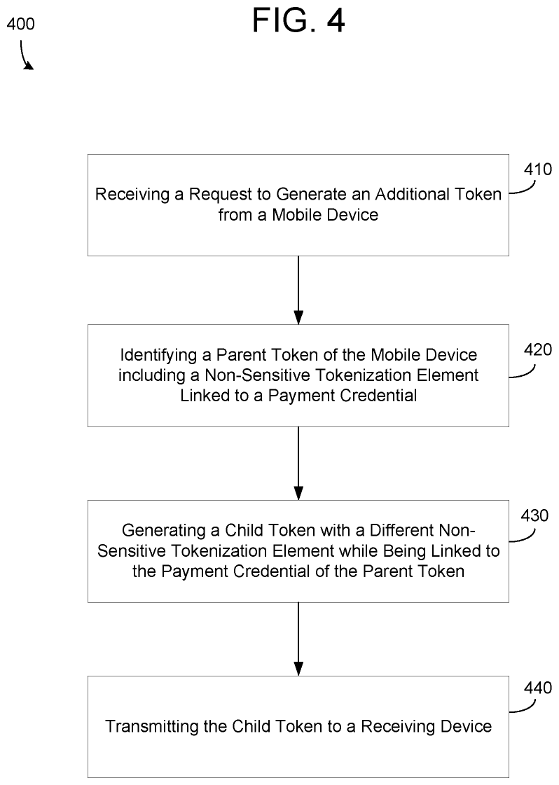

FIG. 4 illustrates a method 400 of generating a child token for mobile payments according to an example embodiment. For example, the method 400 may be performed by a tokenization platform which may include one or more of a server, a database, a cloud storage, a user device, and the like. In some embodiments, steps of the method 400 may be distributed across multiple devices mentioned herein. Referring to FIG. 4, in 410, the method may include receiving a request to generate an additional token from a mobile device. For example, the request may be transmitted from a digital wallet application which includes one or more mobile payment applications. The request may identify a parent token of the digital wallet.

In 420, the method may include identifying the parent token previously issued to the mobile device. The parent token may include a non-sensitive tokenization element (e.g., string, random number, etc.) linked to a payment credential at a tokenization platform. The non-sensitive tokenization element may be a substitute for actual payment card information such as the PAN, expiry, CVC, or the like. In some embodiments, the parent token may have a format of an actual card number, but may not be payment enabled. In other words, the token is not useful without a mapping back to the actual payment card information which is stored at the tokenization server.

In 430, the method may include generating one or more child tokens which are based on the parent token at the tokenization platform. According to various embodiments, the child token may include a different non-sensitive tokenization element than the non-sensitive tokenization element of the parent token while also being linked to the payment credential of the parent token at the tokenization platform. The child token may not be linked to a payment card directly, but may be linked to the parent token at the tokenization server, and therefore, indirectly linked to the payment card linked to the parent token. This can provide the benefit of the ability to create express payments for the child token. For example, rather than requiring the child token to be processed and authorized by an issuing bank of the payment card, the tokenization server can attach funds to the child token making them available almost instantaneously after a payment terminal verifies that the child token still has available funds and is mapped to the parent token. In some embodiments, multiple child tokens may be generated and each may be linked to the parent token. Furthermore, each child token may be designated a different respective non-sensitive tokenization element than the parent token and other child tokens among the multiple child tokens.

In 440, the method includes transmitting the generated child token to a receiving device. In some embodiments, the receiving device may also be the mobile device which stores the parent token. In this way, the mobile device is able to make multiple payments on the same payment card through the child token and the parent token. For example, the parent token and the child token may be configured for processing different payment transactions at the same time.

In some embodiments, the method may further include adding restrictions to the child token at the tokenization platform including one or more restrictions on a daily value limit, a total number of transactions, and a value limit per transaction. The restrictions enable the child token to be customized based on needs of the user/owner, and also based on the use case in which the child token is needed. For example, if the child token is to be used for transit, the child token may be restricted to a few uses per day, with a smaller amount of daily limits. Meanwhile, if the child token is to be used for shopping, travel, or the like, the child token could be restricted with a larger daily limit and transactional amount. In some embodiments, the parent token may be mapped to one or more of the mobile device, a payment application on the mobile device, and a payment card, at the tokenization server, and the child token may be mapped to the parent token at the tokenization server. This type of mapping creates an indirect relationship between the child token and the payment card. In some embodiments, the parent token and the child token are configured for near-field communication (NFC) contactless payment transactions.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

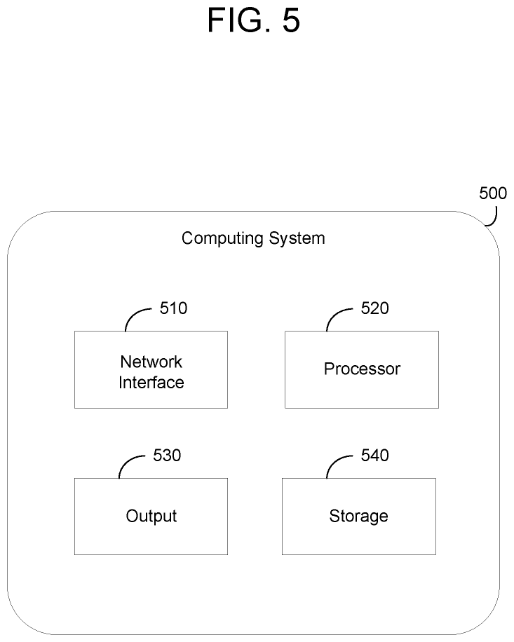

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 5 illustrates an example computer system architecture which may represent or be integrated in any of the above-described components, etc. FIG. 5 is not intended to suggest any limitation as to the scope of use or functionality of embodiments of the application described herein. The computing system 500 is capable of being implemented and/or performing any of the functionality set forth hereinabove.

The computing system 500 may include a computer system/server, which is operational with numerous other general purpose or special purpose computing system environments or configurations. Examples of well-known computing systems, environments, and/or configurations that may be suitable for use as computing system 500 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, and the like, which may include any of the above systems or devices, and the like. According to various embodiments described herein, the computing system 500 may be a tokenization platform, server, CPU, or the like.

The computing system 500 may be described in the general context of computer system-executable instructions, such as program modules, being executed by a computer system. Generally, program modules may include routines, programs, objects, components, logic, data structures, and so on that perform particular tasks or implement particular abstract data types. The computing system 500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computing system 500 is shown in the form of a general-purpose computing device. The components of computing system 500 may include, but are not limited to, a network interface 510, one or more processors or processing units 520, an output 530 which may include a port, an interface, etc., or other hardware, for outputting a data signal to another device such as a display, a printer, etc., and a storage device 540 which may include a system memory, or the like. Although not shown, the computing system 500 may also include a system bus that couples various system components including system memory to the processor 520.

The storage 540 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random access memory (RAM) and/or cache memory. As another example, storage device 540 can read and write to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, storage device 540 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Although not shown, the computing system 500 may also communicate with one or more external devices such as a keyboard, a pointing device, a display, etc.; one or more devices that enable a user to interact with computer system/server; and/or any devices (e.g., network card, modem, etc.) that enable computing system 500 to communicate with one or more other computing devices. Such communication can occur via I/O interfaces. Still yet, computing system 500 can communicate with one or more networks such as a local area network (LAN), a general wide area network (WAN), and/or a public network (e.g., the Internet) via network interface 510. As depicted, network interface 510 may also include a network adapter that communicates with the other components of computing system 500 via a bus. Although not shown, other hardware and/or software components could be used in conjunction with the computing system 500. Examples include, but are not limited to: microcode, device drivers, redundant processing units, external disk drive arrays, RAID systems, tape drives, and data archival storage systems, etc.

Referring to FIG. 5, the network interface 510 may receive a request to generate an additional token from a mobile device. For example, the request may be received from a digital wallet on the mobile device. In response, the processor 520 may identify a parent token previously issued to the mobile device which includes a non-sensitive tokenization element linked to a payment credential at a tokenization platform, and generate a child token of the parent token at the tokenization platform. According to various embodiments, the child token may include a different non-sensitive tokenization element than the non-sensitive tokenization element of the parent token while also being linked to the payment credential of the parent token at the tokenization platform. The processor 520 may control the network interface 510 to transmit the child token to a receiving device such as the mobile device which submitted the request or another device previously approved.

In some embodiments, the non-sensitive tokenization element of the parent token and the child token comprise a format of a payment card number. In some embodiments, the processor 520 is further configured to add restrictions to the child token at the tokenization server including one or more restrictions on a daily value limit, a total number of transactions, and a value limit per transaction. In some embodiments, the parent token and the child token are configured to be used for processing different payment transactions at the same time for the same payment credential.

In some embodiments, the parent token is mapped to the mobile device, a payment application on the mobile device, and a payment card, at the tokenization server, and the child token is mapped to the parent token at the tokenization server. This mapping creates a flexible and indirect mapping between the child token and the payment card because the child token does not need to be verified by the issuing bank, but instead may be verified by the tokenization server based on previously set aside funds which are held in a holding account to guarantee availability. In some embodiments, the processor 520 may generate multiple child tokens which are each linked to the parent token, and each child token may be designated a different respective non-sensitive tokenization element than the parent token and other child tokens among the multiple child tokens.

It will be readily understood that descriptions and examples herein, as generally described and illustrated in the figures, may be arranged and designed in a wide variety of different configurations. Thus, the detailed description of the embodiments is not intended to limit the scope of the application as claimed, but is merely representative of selected embodiments of the application. One of ordinary skill in the art will readily understand that the above may be practiced with steps in a different order, and/or with hardware elements in configurations that are different than those which are disclosed. Therefore, although the application has been described based upon some preferred embodiments, it would be apparent to those of skill in the art that certain modifications, variations, and alternative constructions would be apparent.

What is claimed is:

1. A computing system comprising:
a network interface configured to receive a request to generate an additional token from a mobile device; and
a processor configured to identify a parent token previously issued to the mobile device and comprising a non-sensitive tokenization element linked to a payment credential at a tokenization platform, and generate a child token of the parent token at the tokenization platform, the child token comprising a different non-sensitive tokenization element than the non-sensitive tokenization element of the parent token and being linked to the parent token at the tokenization platform,
wherein the processor is further configured to control the network interface to transmit the child token to a receiving device.

2. The computing system of claim 1, wherein the non-sensitive tokenization element of the parent token and the child token comprise a format of a payment card number.

3. The computing system of claim 1, wherein the mobile device and the receiving device are the same device.

4. The computing system of claim 1, wherein the processor is further configured to add restrictions to the child token at the tokenization server including one or more restrictions on a daily value limit, a total number of transactions, and a value limit per transaction.

5. The computing system of claim 1, wherein the parent token and the child token are configured to be used for processing different payment transactions at the same time for the same payment credential.

6. The computing system of claim 1, wherein the parent token is mapped to the mobile device, a payment application on the mobile device, and a payment card, at the tokenization server, and the child token is mapped to the parent token at the tokenization server.

7. The computing system of claim 1, wherein the parent token and the child token are configured for near-field communication (NFC) contactless payment transactions.

8. The computing system of claim 1, wherein the processor is configured to generate multiple child tokens which are each linked to the parent token, and each child token is designated a different respective non-sensitive tokenization element than the parent token and other child tokens among the multiple child tokens.

9. A method comprising:
receiving a request to generate an additional token from a mobile device;
identifying a parent token previously issued to the mobile device and comprising a non-sensitive tokenization element linked to a payment credential at a tokenization platform;
generating a child token of the parent token at the tokenization platform, the child token comprising a different non-sensitive tokenization element than the non-sensitive tokenization element of the parent token and being linked to the parent token at the tokenization platform; and
transmitting the generated child token to a receiving device.

10. The method of claim 9, wherein the non-sensitive tokenization element of the parent token and the child token comprise a format of a payment card number.

11. The method of claim 9, wherein the mobile device and the receiving device are the same device.

12. The method of claim 9, further comprising adding restrictions to the child token at the tokenization platform including one or more restrictions on a daily value limit, a total number of transactions, and a value limit per transaction.

13. The method of claim 9, wherein the parent token and the child token are configured to be used for processing different payment transactions at the same time for the same payment credential.

14. The method of claim 9, wherein the parent token is mapped to the mobile device, a payment application on the mobile device, and a payment card, at the tokenization server, and the child token is mapped to the parent token at the tokenization server.

15. The method of claim 9, wherein the parent token and the child token are configured for near-field communication (NFC) contactless payment transactions.

16. The method of claim 9, wherein the generating comprises generating multiple child tokens which are each linked to the parent token, and each child token is designated a different respective non-sensitive tokenization element than the parent token and other child tokens among the multiple child tokens.

17. A non-transitory computer-readable medium storing program instructions that, when executed, cause a processor to perform a method comprising:
receiving a request to generate an additional token from a mobile device;
identifying a parent token previously issued to the mobile device and comprising a non-sensitive tokenization element linked to a payment credential at a tokenization platform;
generating a child token of the parent token at the tokenization platform, the child token comprising a different non-sensitive tokenization element than the non-sensitive tokenization element of the parent token and being linked to the parent token at the tokenization platform; and
transmitting the generated child token to a receiving device.

18. The non-transitory computer-readable medium of claim 17, wherein the non-sensitive tokenization element of the parent token and the child token comprise a format of a payment card number.

19. The non-transitory computer-readable medium of claim 17, wherein the method further comprises adding restrictions to the child token at the tokenization platform including one or more restrictions on a daily value limit, a total number of transactions, and a value limit per transaction.

20. The non-transitory computer-readable medium of claim 17, wherein the parent token and the child token are configured to be used for processing different payment transactions at the same time for the same payment credential.
